(19) United States
(12) Patent Application Publication
(10) Pub. No.: US 2025/0104042 A1
(43) Pub. Date: Mar. 27, 2025

(54) RIGHTS MANAGEMENT DEVICE, SYSTEM, METHOD, AND PROGRAM

(71) Applicant: NEC Corporation, Tokyo (JP)

(72) Inventors: Eiji KANEKO, Tokyo (JP); Yoshitomo WARASHINA, Tokyo (JP); Shingo HIROTA, Tokyo (JP)

(73) Assignee: NEC Corporation, Tokyo (JP)

(21) Appl. No.: 18/821,098

(22) Filed: Aug. 30, 2024

(30) Foreign Application Priority Data
Sep. 21, 2023 (JP) 2023-154151

(51) Int. Cl. G06Q 20/22

(52) U.S. Cl. CPC G06Q 20/229

(57) ABSTRACT

The rights management means grants derivative creation rights to a secondary creator based on a rights grant instruction indicating the granting of the derivative creation rights for first content created by a primary creator to the secondary creator. The calculation means calculates a contribution rate indicating a degree to which second content improves an evaluation of the first content based on evaluation information of indicating an evaluation of second content created by the secondary creator who owns the derivative creation rights. The payment amount determination means determines the payment amounts to the primary creator and the secondary creator based on the contribution rate.

### CROSS-REFERENCE TO RELATED APPLICATIONS

This application is based upon and claims the benefit of priority from the prior Japanese Patent Application No. 2023-154151, filed Sep. 21, 2023, the entire contents of which are incorporated herein by reference.

### BACKGROUND OF THE INVENTION

This disclosure relates to a rights management device, a rights management system, a rights management method, and a rights management program for managing information regarding rights.

Generally, a creator acquires copyright when they create content, and they possess ownership of the created content. Furthermore, based on their rights, such as copyright and ownership, the creator can grant usage permissions to other creators for derivative works based on their content. In the following explanation, the creator who created the original content will be referred to as the “primary creator,” and the creator who creates derivative works based on the primary creator's content will be referred to as the “secondary creator.” Examples of secondary creators include authors of derivative works and producers of merchandise related to the works.

Secondary creators can engage in activities utilizing the derivative content they created, and primary creators can earn revenue based on the activities of secondary creators. For instance, Patent Literature 1 describes an information processing device that can distribute gains in content transactions. The information processing device described in Patent Literature 1 distributes profits from collected usage fees to content holders and service providers based on a profit distribution predetermined in the transaction agreement.

### PRIOR ART DOCUMENTS

Patent Document 1: Japanese Patent No. 7132498

### SUMMARY OF THE INVENTION

The value of created content can change depending on how the content is utilized and marketed. In other words, even if profit distribution is pre-determined based on the rights used, as described in Patent Literature 1, the distribution may not necessarily reflect each creator's contribution. Therefore, it is desirable to manage rights utilized based on the created content according to the contributions of the creators.

Therefore, the purpose of this disclosure is to provide a rights management device, a rights management system, a rights management method, and a rights management program capable of managing information related to rights.

The rights management device according to this disclosure includes a rights management means for granting derivative creation rights to a secondary creator based on a rights grant instruction indicating the granting of the derivative creation rights for first content created by a primary creator to the secondary creator, a calculation means for calculating a contribution rate indicating a degree to which second content improves an evaluation of the first content based on evaluation information of indicating an evaluation of second content created by the secondary creator who owns the derivative creation rights, and a payment amount determination means for determining payment amounts to the primary creator and the secondary creator based on the contribution rate.

The rights management system according to this disclosure includes a node participating in a blockchain network, and a terminal device connected to the node, wherein the terminal device includes an instruction means for issuing a rights grant instruction, to the terminal device, indicating the granting of derivative creation rights for first content created by a primary creator to a secondary creator, and the node includes a rights management means for granting the derivative creation rights to the secondary creator based on the rights grant instruction, a calculation means for calculating a contribution rate indicating a degree to which second content improves an evaluation of the first content based on evaluation information of indicating an evaluation of second content created by the secondary creator who owns the derivative creation rights, and a payment amount determination means for determining payment amounts to the primary creator and the secondary creator based on the contribution rate.

The rights management method according to this disclosure includes: granting derivative creation rights to a secondary creator based on a rights grant instruction indicating the granting of the derivative creation rights for first content created by a primary creator to the secondary creator; calculating a contribution rate indicating a degree to which second content improves an evaluation of the first content based on evaluation information of indicating an evaluation of second content created by the secondary creator who owns the derivative creation rights; and determining payment amounts to the primary creator and the secondary creator based on the contribution rate.

The rights management program according to this disclosure causing a computer to execute: rights management process for granting derivative creation rights to a secondary creator based on a rights grant instruction indicating the granting of the derivative creation rights for first content created by a primary creator to the secondary creator; calculation process for calculating a contribution rate indicating a degree to which second content improves an evaluation of the first content based on evaluation information of indicating an evaluation of second content created by the secondary creator who owns the derivative creation rights; and payment amount determination process for determining payment amounts to the primary creator and the secondary creator based on the contribution rate.

According to this disclosure, information about rights can be managed.

### BRIEF DESCRIPTION OF DRAWINGS

FIG. 1 is a block diagram showing a configuration example of a rights management system according to one example embodiment of the present disclosure.

FIG. 2 is an explanatory diagram showing an example of a process for calculating contribution rates and damage rates.

FIG. 3 is a flowchart showing an example of the operation of the rights management system.

FIG. 4 is a block diagram showing an overview of the rights management device according to the present disclosure.

FIG. 5 is a block diagram showing an overview of the rights management system according to the present disclosure.

### DETAILED DESCRIPTION OF THE INVENTION

First, the market where transactions are conducted through the content created by creators (hereinafter referred to as the “creator market”) will be explained. Customers in the creator market include creators and content production (distribution) companies. Examples of creators in media or art fields include manga artists, writers, illustrators, animators, musicians, avatars, and worlds. Even if these creators study until graduation at a vocational school, there is no guarantee

of finding a job, and it is also challenging to promote their created content independently. Specifically, individual content creators before being employed find it difficult to manage and trade the ownership of content and the methods of returning profits to the authors on their own, and it is also challenging to broadcast to mass communication.

Here, an original content creator in the creator market is defined as “primary creator.” The primary creator is individual who creates new content based on their unique ideas or concepts, such as a manga artist, a writer, an illustrator, an animator, a musician, and a computer programmer. Furthermore, an individual who creates new content or a work based on the original content created by the primary creator is defined as “secondary creator.” The secondary creator is an individual who reuses or arranges the original content to create new value.

In a typical creator market, it is challenging to manage clear regulations regarding rights and rewards between primary creators and secondary creators. In such situations, it is difficult for primary creators to receive adequate rewards, and incentives for secondary creators' activities also decrease.

As a more specific problem, in a typical creator market, the distribution of rights and rewards between primary creators and secondary creators is often opaque. In such cases, because appropriate rewards for the primary creators are not guaranteed, there is a possibility that the incentive for creative activities will decrease.

Moreover, it is challenging to clearly evaluate the relationship and brand value between derivative works and original works. Furthermore, opaque reward distribution can affect the trust relationship between primary creator and secondary creator, potentially hindering the overall development of creative activities.

Therefore, this disclosure describes a platform that allows creators, even those unfamiliar with rights management, to manage their content rights independently. This allows such creators to engage in transactions with mass communication. Below, example embodiments of the present disclosure will be described with reference to the drawings.

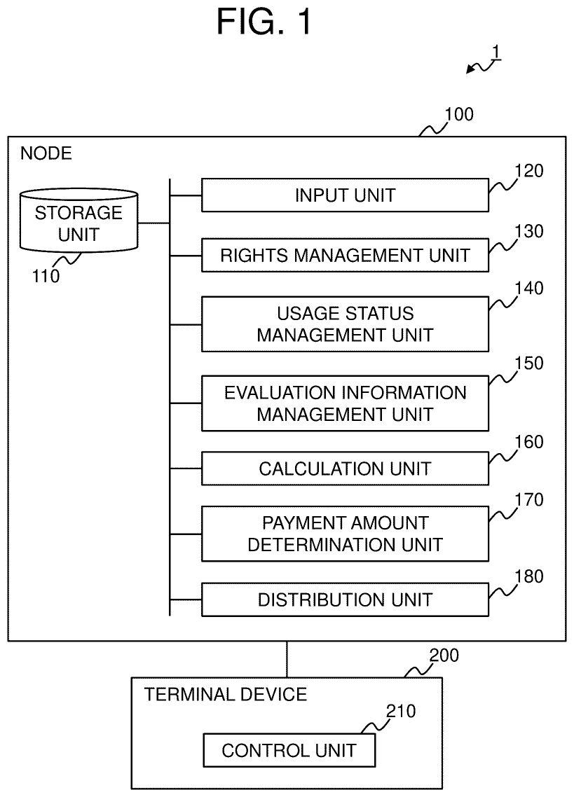

FIG. 1 is a block diagram showing a configuration example of a rights management system according to one example embodiment of the present disclosure. The rights management system 1 shown in FIG. 1 includes a node 100 and a terminal device 200 connected to the node 100 via a communication network. The node 100 in the present disclosure can be referred to as a rights management device as it manages various information based on the rights held by creators.

In this example embodiment, the node 100 is assumed to be a device participating in a blockchain network. The form of blockchain assumed in this example embodiment is arbitrary and may be a public blockchain, a private blockchain, or a consortium blockchain. Note that the node 100 does not necessarily need to participate in the blockchain network. However, participating in the blockchain network allows for various effects of blockchain technology, making it more desirable.

The terminal device 200 is a device used by creators when performing various processes. The form of the terminal device 200 is also arbitrary, such as a smartphone or a tablet device. The terminal device 200 includes a control unit 210.

The control unit 210 controls various processes performed by the terminal device 200. In this example embodiment, the control unit 210 instructs the node 100 (hereinafter referred to as “rights grant instruction”) to grant the rights to create derivative works of the content (hereinafter referred to as “derivative creation rights”) created by the primary creator (hereinafter referred to as “first content”) to the secondary creator, in accordance with the instructions from the primary creator.

In this example embodiment, the derivative creation rights are granted to the secondary creator using a NFT (Non-Fungible Token) created based on the blockchain. The NFT granted in this way is sometimes hereafter referred to as derivative creation rights NFT. More specifically, derivative creation rights NFT is issued on the blockchain, with the owner being the secondary creator, granting derivative creation rights to the secondary creator. Managing rights using such derivative creation rights NFT ensures uniqueness and prevents tampering with records such as ownership.

The control unit 210 generates transactions indicating a rights grant instruction according to the form of the blockchain used and sends the generated transactions as requests to the blockchain network (more specifically, the node 100), recording them in the blockchain (more specifically, the storage unit 110 of the node 100, described later). The method of generating transactions and recording them in the blockchain is widely known and will not be described in detail here.

The node 100 includes a storage unit 110, an input unit 120, a rights management unit 130, a usage status management unit 140, an evaluation information management unit 150, a calculation unit 160, a payment amount determination unit 170, and a distribution unit 180.

The input unit 120, the rights management unit 130, the usage status management unit 140, the evaluation information management unit 150, the calculation unit 160, the payment amount determination unit 170, and the distribution unit 180 are realized by a computer processor (e.g., CPU (Central Processing Unit), GPU (Graphics Processing Unit)) operating according to a program (rights management program).

For example, the program may be stored in the storage unit 110 of the node 100, and the processor may read the program and operate as the input unit 120, the rights management unit 130, the usage status management unit 140, the evaluation information management unit 150, the calculation unit 160, the payment amount determination unit 170, and the distribution unit 180 according to the program.

In this example embodiment, the functions of the input unit 120, the rights management unit 130, the usage status management unit 140, the evaluation information management unit 150, the calculation unit 160, the payment amount determination unit 170, and the distribution unit 180 are realized based on the mechanism of a smart contract in the blockchain. In other words, using the smart contract mechanism, specific functions are executed on the blockchain when certain conditions are met.

For example, in NFT transactions, the smart contract mechanism is used, and when NFTs are traded, the NFT ownership on the blockchain is automatically updated at the same time as the NFT transfer through the smart contract mechanism.

Note that part or all of each component of the node 100 may be realized by multiple information processing devices or circuits, these information processing devices or circuits may be centrally or distributed. For example, the information processing devices or circuits may be realized as a client-server system or a cloud computing system connected via a communication network.

The storage unit 110 stores various information used when the node 100 processes. Additionally, the storage unit 110 stores various transactions managed according to the form of the blockchain. The storage unit 110 is realized, for example, by a magnetic disk.

The input unit 120 accepts inputs of transactions and records the accepted transactions in the storage unit 110. The method of storing the accepted transactions in blocks and propagating blocks among nodes is widely known in blockchain network technology and will not be described in detail here.

The rights management unit 130 issues derivative creation rights NFTs to a secondary creator as owners when receiving a rights grant instruction from the terminal device 200. The derivative creation rights NFTs may include various attributes such as a contribution rate, a damage rate, the duration of derivative creation rights, and other attributes described later, in addition to information identifying the secondary creator as the owner.

Moreover, the rights management unit 130 invalidates the derivative creation rights if the damage rate calculated by the calculation unit 160, described later, meets a predefined condition. The rights management unit 130 may delete the derivative creation rights NFT itself or change the owner of the derivative creation rights NFT.

The usage status management unit 140 manages the usage status of the content based on the secondary creator's derivative creation rights (hereinafter referred to as “secondary content”). Specifically, the usage status management unit 140 records the usage status in the storage unit 110.

The secondary content is based on the derivative creation rights and can be considered content authorized by the primary creator. The content of the secondary content is arbitrary and may be the same as the content of the first content or newly created content by the secondary creator. The usage status indicates any situation where the secondary content is utilized, such as transfer activities, display activities, or lending activities.

An example of a specific usage status is when the secondary creator sells the secondary content to consumers. The sale of secondary content may be conducted using the smart contract mechanism. If transactions are conducted based on predefined rules or contracts, the usage status management unit 140 may record the transaction details (transaction results, etc.) in the storage unit 110.

The evaluation information management unit 150 manages information indicating the evaluation of the second content by the users related to the second content (hereinafter referred to as “evaluation information”). Specifically, the evaluation information management unit 150 accepts the evaluation information of the second content by evaluators and stores it in the storage unit 110. The evaluator's personal information does not necessarily need to be specified, and the evaluator's ID can be, for example, a wallet holding NFTs.

The evaluation information management unit 150 may use a voting algorithm implemented in smart contracts to accept a vote from evaluators and use the content of the vote as evaluation information. The acceptance method is not limited to voting and may be a questionnaire or other methods.

Furthermore, the target evaluators may be predetermined. Evaluators may be users who actually used the second content or users in the community interested in the first content or second content. The content of the evaluation is arbitrary as long as it allows recognition of the evaluation of the second content, such as “good/bad” in binary or scores (percentages).

Moreover, the content of the evaluation is not limited to quantified information and can include text information such as evaluator comments. In this case, the evaluation information may be created by determining the content of the evaluation from the input text information using text mining techniques or a learned model that has learned the goodness of the evaluation based on the text. If the creation of such evaluation information is realized by smart contracts, the validity of the evaluation information creation process can also be ensured.

The calculation unit 160 calculates the contribution rate indicating the degree to which second content improves an evaluation of the first content based on the evaluation information. Furthermore, the calculation unit 160 calculates the damage rate indicating a degree of decrease in the evaluation of the first content by the second content based on the evaluation information.

The evaluation information represents the evaluation of the second content. However, if the result is an increase in the evaluation of the second content, it will be considered as having contributed to the evaluation of the first content that was the basis for the creation of the second content, and if the result is a decrease in the evaluation of the second content, it will be considered as having also damaged the evaluation of the first content. Therefore, in this example embodiment, the evaluation information is treated as equivalent to the evaluation of the first content.

The calculation unit 160 may calculate the contribution rate and damage rate at the timing of distributing payment amounts to creators described later. The method of calculating the contribution rate and damage rate is not particularly limited. For example, if the evaluation information by each evaluator is expressed as percentages of contribution rate and damage rate, the calculation unit 160 may calculate the average value of the evaluation information (specifically, the contribution rate and the damage rate included in the evaluation information of each evaluator) to calculate the contribution rate and the damage rate of the secondary creator.

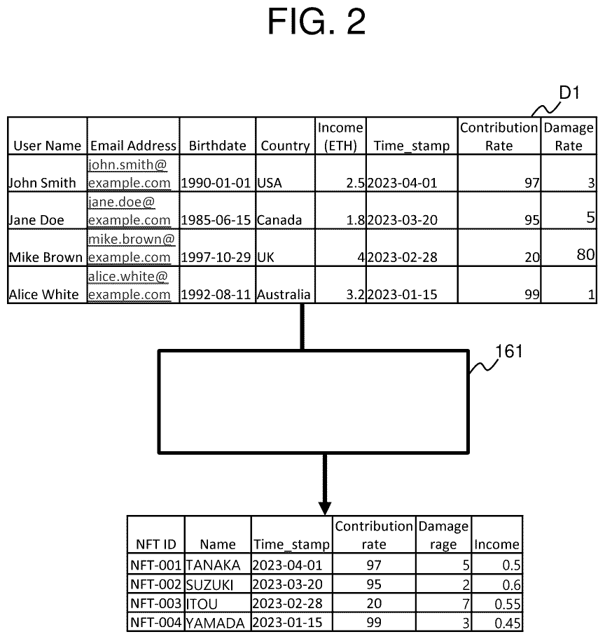

FIG. 2 is an explanatory diagram showing an example of a process for calculating contribution rates and damage rates. The voting result DI exemplified in FIG. 2 shows an example where four evaluators vote for contribution rates and damage rates expressed in percentages. In this case, it shows that the calculation unit 160 (smart constructor 161) aggregates the contribution rate and damage rate as the voting result and calculates the contribution rate and damage rate of the secondary creator. The calculation unit 160 may also notify the evaluators and secondary creators of the contribution rate and damage rate.

The payment amount determination unit 170 determines the payment amounts to the primary creator and the secondary creator based on the contribution rate and damage rate. Note that the payment amount determination unit 170 may determine the distribution rate representing the ratio of payment amounts distributed to the primary creator and the secondary creator instead of the payment amount. Below, specific examples of calculation methods for determining payment amounts will be explained. Note that the following explanation exemplifies ETH (Ether), a type of virtual currency.

As a first specific example, a fixed amount-based calculation method is cited. The payment amount determination unit 170 may fix the basic payment amount (0.1 ETH in this example) and determine the payment amount based on the Equation 1 shown below, considering the contribution rate and damage rate.

$$Payment amount = Basic payment amount + ( Basic payment amount \times Contribution rate ) - ( Basic payment amount \times Damage rate ) \qquad ( Equation 1 )$$

As a second specific example, a contribution rate-based calculation method is cited. For example, the maximum payment amount is predetermined (0.1 ETH in this example), and the payment amount determination unit 170 may determine the payment amount based on the Equation 2 shown below, considering the contribution rate and damage rate.

$$Payment amount = Maximum payment amount \times Contribution rate - Maximum payment amount \times Damage rate \qquad ( Equation 2 )$$

As a third specific example, a sliding scale calculation method is cited. Specifically, different payment amounts are set according to the range of contribution rates and damage rates, and the payment amount determination unit 170 may determine the payment amount based on the set criteria. For example, the following setting contents are exemplified.
Contribution rate 90% or more: Payment amount=0.10 ETH
Contribution rate 80% or more but less than 90%: Payment amount=0.08 ETH
Contribution rate 70% or more but less than 80%: Payment amount=0.06 ETH

As a fourth specific example, a method of setting the minimum and maximum payment amounts and ensuring that the calculated payment amount does not exceed the set minimum and maximum values is cited. For example, the minimum and maximum payment amounts are predetermined (minimum payment amount=0.01 ETH, maximum payment amount=0.1 ETH in this example), and the payment amount determination unit 170 may determine the payment amount within that range. For example, the following setting contents are exemplified.

$$Payment amount = Maximum payment amount \times Contribution rate - Maximum payment amount \times Damage rate$$

However,
If the payment amount<minimum payment amount, the payment amount=minimum payment amount
If the payment amount>maximum payment amount, the payment amount=maximum payment amount

In this example embodiment, an example where the payment amount determination unit 170 uses both the contribution rate and the damage rate was explained. However, the calculation of payment amounts may use only one of the indicators, either the contribution rate or the damage rate. For example, the payment amount determination unit 170 may calculate the payment amount using only the contribution rate or the damage rate. For example, if the payment amount determination unit 170 uses only the contribution rate, the distribution unit 180 described later may distribute the predetermined payment amount based on the secondary creator's contribution rate.

The distribution unit 180 distributes the determined payment amounts to the primary creator and the secondary creator. The method of distributing the payment amount is arbitrary. The distribution unit 180 may distribute the payment amount using virtual currency used in the blockchain network. Alternatively, the distribution unit 180 may transfer the payment amount to the designated accounts of each creator.

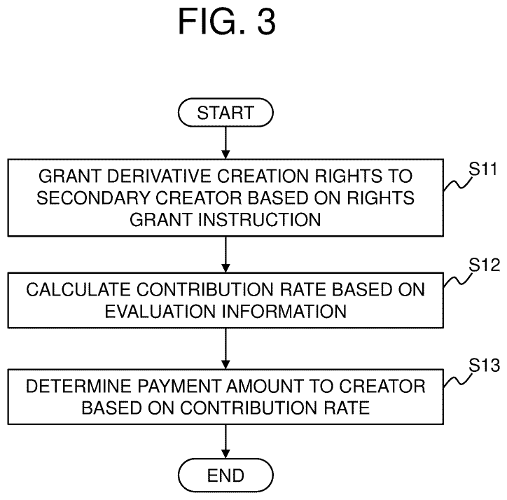

Next, an operation example of the rights management system 1 of this example embodiment will be explained. FIG. 3 is a flowchart showing an example of the operation of the rights management system 1 of this example embodiment. The rights management unit 130 grants derivative creation rights to the secondary creator based on the rights grant instruction received from the terminal device 200 (Step S11). The calculation unit 160 calculates the contribution rate based on the evaluation information (Step S12). The payment amount determination unit 170 determines the payment amounts to the primary creator and the secondary creator based on the contribution rate (Step S13).

As described above, in this example embodiment, the rights management unit 130 grants derivative creation rights to the secondary creator based on the rights grant instruction, the calculation unit 160 calculates the contribution rate based on the evaluation information, and the payment amount determination unit 170 determines the payment amounts to the primary creator and the secondary creator based on the contribution rate. Therefore, it is possible to manage information related to rights.

For example, in a typical platform, when the primary creator grants usage permission for the content to the secondary creator, there is a risk that the brand value of the created content may be damaged. Additionally, the secondary creator may face higher hurdles to obtain authorization from the primary creator due to these concerns.

On the other hand, in this example embodiment, the rights management unit 130 invalidates derivative creation rights if the damage rate meets predefined conditions. Therefore, the risks anticipated by the primary creator can be reduced, and this risk reduction is expected to lower the hurdles for secondary creators to obtain authorization. This makes it easier for amateur content creators, for example, to manage their own work and sell it to the mass communication. Furthermore, in this example embodiment, since the node 100 participates in the blockchain

network, it is possible to use blockchain technology. Specifically, in this example embodiment, the rights management unit 130 grants derivative creation rights to the secondary creator by issuing derivative creation rights NFTs. In this way, the ownership of the content can be proved using derivative creation rights NFTs, which are not affected by moral rights, and can guarantee that the primary creator (the original author) is duly paid (some profits are returned) even in the case of secondary distribution.

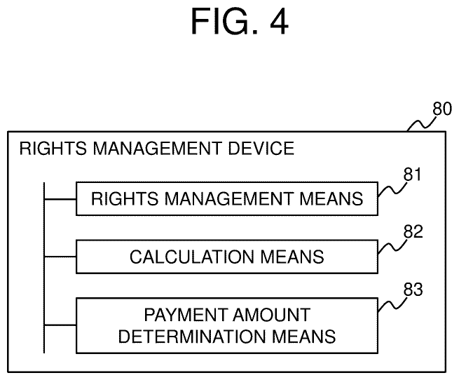

Next, an overview of the present disclosure will be explained. FIG. 4 is a block diagram showing an overview of the rights management device according to the present disclosure. The rights management device 80 (e.g., node 100) according to the present disclosure includes a rights management means 81 (e.g., rights management unit 130) for granting derivative creation rights to a secondary creator based on a rights grant instruction indicating the granting of the derivative creation rights for first content created by a primary creator to the secondary creator, a calculation means 82 (e.g., calculation unit 160) for calculating a contribution rate indicating a degree to which second content improves an evaluation of the first content based on evaluation information of indicating an evaluation of second content created by the secondary creator who owns the derivative creation rights, and a payment amount determination means 83 (e.g., payment amount determination unit 170) for determining the payment amounts to the primary creator and the secondary creator based on the contribution rate.

With such a configuration, it is possible to manage information related to rights.

Moreover, the calculation means 82 may calculate a damage rate indicating a degree of decrease in evaluation of the first content by the second content based on the evaluation information, and the payment amount determination means 83 may determine the payment amounts to the primary creator and the secondary creator based on the contribution rate and the damage rate.

Furthermore, the rights management means 81 may invalidate derivative creation rights if the damage rate meets predefined conditions. This makes it possible to stop payment amounts based on derivative creation rights.

Moreover, the rights management means 81 may grant derivative creation rights to the secondary creator by issuing a derivative creation rights NFT created based on the blockchain used. This ensures uniqueness and prevents tampering with records such as ownership.

Additionally, the rights management device 80 may include an evaluation information management means (e.g., evaluation information management unit 150) for managing evaluation information of the second content evaluated by users related to the second content. The calculation means 82 may calculate the contribution rate and the damage rate based on the evaluation information. By managing information evaluated by users related to the second content, it is possible to calculate more appropriate contribution rates and damage rates.

Specifically, the evaluation information management means may accept a vote from an evaluator using a voting algorithm implemented in a smart contract and manage the content of the vote as evaluation information. Using such a mechanism ensures the validity of the evaluation information.

Specifically, the evaluation information management means may manage multiple evaluation information expressed as percentages of contribution rates and damage rates. The calculation means 82 may calculate average values of the contribution rates and damage rates included in each evaluation information to calculate the contribution rate and damage rate of the secondary creator.

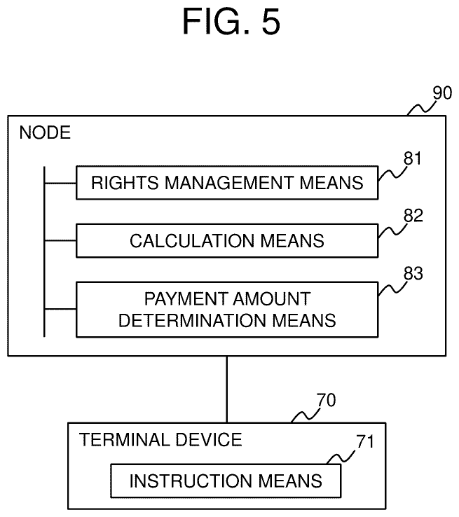

FIG. 5 is a block diagram showing an overview of the rights management system according to the present disclosure. The rights management system (e.g., rights management system 1) according to the present disclosure includes a node 90 (e.g., node 100) participating in a blockchain network and a terminal device 70 (e.g., terminal device 200) connected to the node 90.

The terminal device 70 includes an instruction means 71 (e.g., control unit 210) for issuing a rights grant instruction, to the terminal device, indicating the granting of derivative creation rights for first content created by a primary creator to a secondary creator.

The node 90 includes a rights management means 81, a calculation means 82, and a payment amount determination means 83. The content of the rights management means 81, the calculation means 82, and the payment amount determination means 83 is the same as those illustrated in FIG. 4.

Such a configuration also allows for the management of information related to rights.

Although some or all of the above example embodiments may also be described as in the following Supplementary notes, but not limited to the following.

(Supplementary note 1) A rights management device comprising:
a rights management means for granting derivative creation rights to a secondary creator based on a rights grant instruction indicating the granting of the derivative creation rights for first content created by a primary creator to the secondary creator;
a calculation means for calculating a contribution rate indicating a degree to which second content improves an evaluation of the first content based on evaluation information of indicating an evaluation of second content created by the secondary creator who owns the derivative creation rights; and
a payment amount determination means for determining payment amounts to the primary creator and the secondary creator based on the contribution rate.

(Supplementary note 2) The rights management device according to Supplementary note 1, wherein,
the calculation means calculates a damage rate indicating a degree of decrease in evaluation of the first content by the second content based on the evaluation information, and
the payment amount determination means determines the payment amounts to the primary creator and the secondary creator based on the contribution rate and the damage rate.

(Supplementary note 3) The rights management device according to Supplementary note 2, wherein
the rights management means invalidates the derivative creation rights if the damage rate meets a predefined condition.

(Supplementary note 4) The rights management device according to Supplementary note 1 or 2, wherein
the rights management means grants the derivative creation rights to the secondary creator by issuing a derivative creation rights NFT (Non-Fungible Token) created based on the blockchain used.

(Supplementary note 5) The rights management device according to Supplementary note 2 or 3, further comprising
an evaluation information management means for managing evaluation information of the second content evaluated by users related to the second content, wherein
the calculation means calculates the contribution rate and the damage rate based on the evaluation information.

(Supplementary note 6) The rights management device according to Supplementary note 5, wherein
the evaluation information management means accepts a vote from an evaluator using a voting algorithm implemented in a smart contract and manages the content of the vote as evaluation information.

(Supplementary note 7) The rights management device described in Supplementary note 5, wherein
the evaluation information management means manages multiple evaluation information expressed as percentages of contribution rates and damage rates, and
the calculation means calculates average values of the contribution rates and damage rates included in each evaluation information to calculate the contribution rate and damage rate of the secondary creator.

(Supplementary note 8) A rights management system comprising:
a node participating in a blockchain network; and
a terminal device connected to the node, wherein
the terminal device includes an instruction means for issuing a rights grant instruction, to the terminal device, indicating the granting of derivative creation rights for first content created by a primary creator to a secondary creator, and
the node includes:
   a rights management means for granting the derivative creation rights to the secondary creator based on the rights grant instruction;
   a calculation means for calculating a contribution rate indicating a degree to which second content improves an evaluation of the first content based on evaluation information of indicating an evaluation of second content created by the secondary creator who owns the derivative creation rights; and
   a payment amount determination means for determining payment amounts to the primary creator and the secondary creator based on the contribution rate.

(Supplementary note 9) The rights management system according to Supplementary note 8, wherein
the calculation means calculates a damage rate indicating degree of decrease in evaluation of the first content by the second content based on the evaluation information, and
the payment amount determination means determines the payment amounts to the primary creator and the secondary creator based on the contribution rate and the damage rate.

(Supplementary note 10) A rights management method by a computer comprising:
granting derivative creation rights to a secondary creator based on a rights grant instruction indicating the granting of the derivative creation rights for first content created by a primary creator to the secondary creator;
calculating a contribution rate indicating a degree to which second content improves an evaluation of the first content based on evaluation information of indicating an evaluation of second content created by the secondary creator who owns the derivative creation rights; and
determining payment amounts to the primary creator and the secondary creator based on the contribution rate.

(Supplementary note 11) A rights management program causing a computer to execute:
rights management process for granting derivative creation rights to a secondary creator based on a rights grant instruction indicating the granting of the derivative creation rights for first content created by a primary creator to the secondary creator;
calculation process for calculating a contribution rate indicating a degree to which second content improves an evaluation of the first content based on evaluation information of indicating an evaluation of second content created by the secondary creator who owns the derivative creation rights; and
payment amount determination process for determining payment amounts to the primary creator and the secondary creator based on the contribution rate.

Although the disclosure has been described above with reference to the example embodiments, the disclosure is not limited to the example embodiments described above. Various changes can be made to the configuration and details of the disclosure that can be understood by those skilled in the art within the scope of this disclosure. And each example embodiment can be combined with other example embodiments as appropriate.
1 Rights management system
100 Node
110 Storage unit
120 Input unit
130 Rights management unit
140 Usage status management unit
150 Evaluation information management unit
160 Calculation unit
170 Payment amount determination unit
180 Distribution unit
200 Terminal device
210 Control unit

1. A rights management device comprising:
a memory storing instructions; and
one or more processors configured to execute the instructions to:
grant derivative creation rights to a secondary creator based on a rights grant instruction indicating the granting of the derivative creation rights for first content created by a primary creator to the secondary creator;
calculate a contribution rate indicating a degree to which second content improves an evaluation of the first content based on evaluation information of indicating an evaluation of second content created by the secondary creator who owns the derivative creation rights; and
determine payment amounts to the primary creator and the secondary creator based on the contribution rate.

2. The rights management device according to claim 1, wherein the processor is configured to execute the instructions to:
calculate a damage rate indicating a degree of decrease in evaluation of the first content by the second content based on the evaluation information; and
determine the payment amounts to the primary creator and the secondary creator based on the contribution rate and the damage rate.

3. The rights management device according to claim 2, wherein the processor is configured to execute the instructions to invalidate the derivative creation rights if the damage rate meets a predefined condition.

4. The rights management device according to claim 1, wherein the processor is configured to execute the instructions to grant the derivative creation rights to the secondary creator by issuing a derivative creation rights NFT (Non-Fungible Token) created based on the blockchain used.

5. The rights management device according to claim 2, wherein the processor is configured to execute the instructions to:
manage evaluation information of the second content evaluated by users related to the second content; and
calculate the contribution rate and the damage rate based on the evaluation information.

6. The rights management device according to claim 5, wherein the processor is configured to execute the instructions to accept a vote from an evaluator using a voting algorithm implemented in a smart contract and manage the content of the vote as evaluation information.

7. A rights management system comprising:
a node participating in a blockchain network; and
a terminal device connected to the node, wherein
the terminal device issues a rights grant instruction, to the terminal device, indicating the granting of derivative creation rights for first content created by a primary creator to a secondary creator, and
the node includes:
a memory storing instructions; and
one or more processors configured to execute the instructions to:
grant the derivative creation rights to the secondary creator based on the rights grant instruction;
calculate a contribution rate indicating a degree to which second content improves an evaluation of the first content based on evaluation information of indicating an evaluation of second content created by the secondary creator who owns the derivative creation rights; and
determine payment amounts to the primary creator and the secondary creator based on the contribution rate.

8. The rights management system according to claim 7, wherein the processor is configured to execute the instructions to:
calculate a damage rate indicating degree of decrease in evaluation of the first content by the second content based on the evaluation information; and
determine the payment amounts to the primary creator and the secondary creator based on the contribution rate and the damage rate.

9. A rights management method by a computer comprising:
granting derivative creation rights to a secondary creator based on a rights grant instruction indicating the granting of the derivative creation rights for first content created by a primary creator to the secondary creator;
calculating a contribution rate indicating a degree to which second content improves an evaluation of the first content based on evaluation information of indicating an evaluation of second content created by the secondary creator who owns the derivative creation rights; and
determining payment amounts to the primary creator and the secondary creator based on the contribution rate.

10. A non-transitory computer readable information recording medium storing a rights management program causing a computer to execute:
rights management process for granting derivative creation rights to a secondary creator based on a rights grant instruction indicating the granting of the derivative creation rights for first content created by a primary creator to the secondary creator;
calculation process for calculating a contribution rate indicating a degree to which second content improves an evaluation of the first content based on evaluation information of indicating an evaluation of second content created by the secondary creator who owns the derivative creation rights; and
payment amount determination process for determining payment amounts to the primary creator and the secondary creator based on the contribution rate.
